(19) United States
(12) Patent Application Publication
(10) Pub. No.: US 2018/0117479 A1
(43) Pub. Date: May 3, 2018

(54) Voice-Enabled Connected Smart Toy

(71) Applicant: Elemental Path, Inc., New York, NY (US)

(72) Inventors: Donald Coolidge, New York, NY (US); John Paul Benini, New York, NY (US); Sean O'Shea, New York, NY (US); Arthur Tu, New York, NY (US); Jessica Cohen, New York, NY (US); Mark Garcia, New York, NY (US); Tinashe Musonza, Brooklyn, NY (US); Shane Tierney, Queens, NY (US); Calvin Chu, New York, NY (US)

(73) Assignee: Elemental Path, Inc., New York, NY (US)

(21) Appl. No.: 15/703,489

(22) Filed: Sep. 13, 2017

Related U.S. Application Data
(60) Provisional application No. 62/394,004, filed on Sep. 13, 2016.

(51) Int. Cl. A63H 3/28; A63H 3/00; G09B 5/00; A63H 3/36; G09B 5/04; G06N 5/02; G06N 99/00

(52) U.S. Cl. CPC A63H 3/28; H04W 76/02; A63H 3/006; G09B 5/00; H04W 80/10; G09B 5/04; G06N 5/022; G06N 99/005; A63H 3/36

(57) ABSTRACT

A smart toy is provided. The smart toy includes a housing forming a zoomorphic shell for housing internal components. The smart toy also includes a microphone for receiving an audio signal from a child and a speaker for playing a responsive audio signal to the child. The smart toy further includes an actuator button and a microprocessor for establishing a voice call with a remote server when the actuator button is pressed. The microprocessor processes the audio signal received from the child and sends the audio signal to the remote server. The remote server processes the audio signal using a dialog engine and a knowledge database to generate the responsive audio signal which is tailored to the child and responsive to the audio signal. The remote server sends the responsive audio signal to the microprocessor to be played to the child.

### RELATED APPLICATIONS

This application claims priority to U.S. Provisional Patent Application Ser. No. 62/394,004 filed on Sep. 13, 2016, the entire disclosure of which is hereby incorporated by reference.

### BACKGROUND

### Field of the Disclosure

The present disclosure relates to an electro-mechanical device that leverages big data and machine learning. More particularly, the present disclosure relates to a voice-enabled connected smart toy.

### Related Art

Socio-linguistic development is crucial in preparing users such as young children for higher level comprehension and problem-solving tasks. Many educational content applications are available for children via electronic devices such as tablets, phones, and computers. Delivery via a screen has several drawbacks: blue light that affects sleep patterns; too much ‘screen time’; eye strain; and an impersonal delivery of content, among other drawbacks. Some children's cognitive skills develop better when the content is delivered via a physical zoomorphic or anthropomorphic form such as a toy or a doll.

Current products do not use artificial intelligence that has been tailored to children. They generate unrealistic and impersonal interactions. These are triggered, canned responses that do not relate to a child's use of language, or subject matters of interest to a child. Most current devices offer one-way utterances, or two-way question-and-answer, but not a real conversation that builds one sentence upon the content of the previous sentence. Furthermore, current products do not learn about a specific user and use that knowledge to improve interactions.

In some cases, current dialog devices are also somewhat unintelligible to children. Current dialog devices offer full access to web content, without any filters for appropriate content for children. In addition, they do not offer feedback to parents regarding a child's progress or usage.

Some current inventions for kids can access the internet, but only while in range of second wireless-capable device, such as a smartphone. This usually creates a scenario in which the parents leaves device's proximity, taking their smartphone, and the child's toy becomes lifeless.

What is needed therefore is a device, that that employs artificial intelligence to educate and socialize with children, for a two-way conversation, and to learn the child's personality; that possesses a zoomorphic or anthropomorphic form; that can independently access semantic and knowledge databases to search for answers, via a built-in wifi protocol; and that can display metrics and content filters to a second user, or guardian.

### SUMMARY

The present invention relates to an electro-mechanical device that integrates a humanist interface with big data. The invention can include a device, or toy, verbally interacts with a user, such as a child; a semantic and knowledge database, and a third-party content management system in communication with the toy. The device accompanies a child through everyday activities in order to aid the child in reasoning about his or her surroundings, to cultivate the child's ability to interact with the physical world, and to teach academic subjects such as math, language, and basic factual knowledge. The present invention addresses the style and content of children's language. The invention is a system that comprises a device with wireless Internet, a semantic database or dialog engine, and an interface for managing the device content. The purpose of the invention is to improve cognitive skills via programmed educational content delivered in an audio-lingual engagement. The invention interacts with different users, one, such as a child, who operates and communicates with the device, and another, such as a parent, who monitors and adjusts this first user's engagement via an interface. The inventors contemplate scenarios in which multiple toys can communicate with each other. The inventors also contemplate future uses of the technology as standalone artificial intelligence that may be applied to other toys, devices, and systems.

### BRIEF DESCRIPTION OF THE DRAWINGS

The foregoing features of the disclosure will be apparent from the following Detailed Description, taken in connection with the accompanying drawings, in which:

FIG. 1 is an isometric view of a device of the present disclosure;

FIG. 2 is a right side view of the device;

FIG. 3 is a sectional (cut-away) view of the device revealing its inner components;

FIG. 4 is a second sectional (cut-away) view of the device revealing its inner components;

FIGS. 5A-5C are an electrical schematics of circuitry of the device;

FIG. 6A is a system architecture diagram;

FIG. 6B is a flowchart illustrating processing steps carried out by the device;

FIG. 7A is a block diagram of the dialog engine (e.g., adaptive learning engine) of FIG. 6A;

FIG. 7B is a flowchart illustrating processing steps in accordance with the present disclosure for semantic reasoning of natural language;

FIGS. 8-24 are screenshots of embodiments of a content management interface of the present disclosure; and

FIG. 25 is a isometric view of another embodiment of the device.

### DETAILED DESCRIPTION

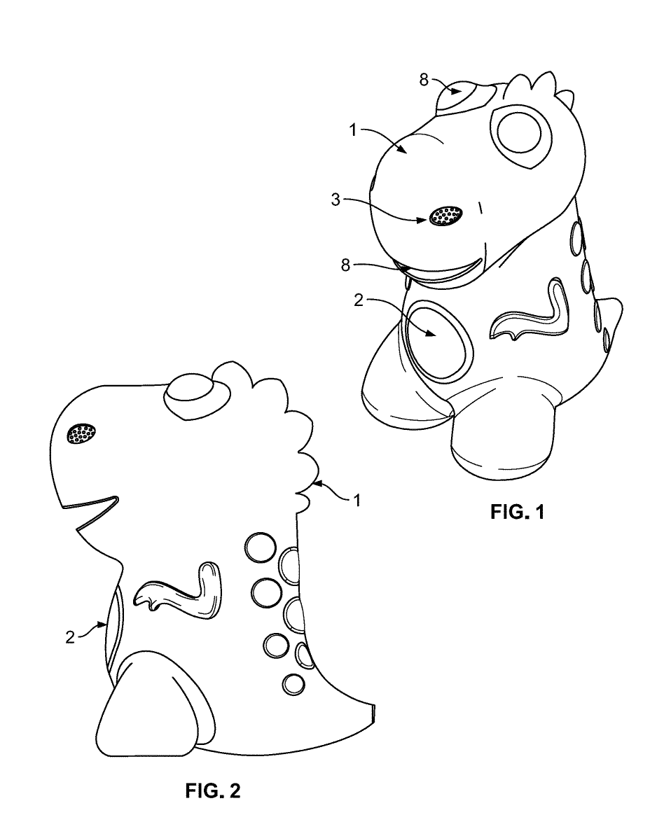

The present disclosure relates to a voice-enabled connected smart toy, as discussed in detail below in connection with FIGS. 1-25.

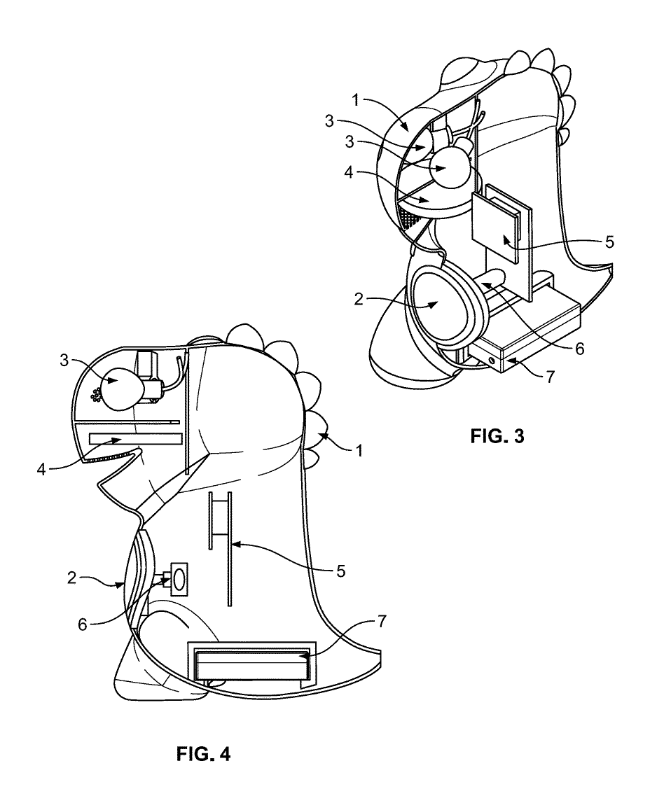

FIG. 1 is an isometric view of a device of the present disclosure and FIG. 2 is a side view of the device of the present disclosure. The device can include a cosmetic shell 1, an actuating button 2, a microphone 3, and a plurality of decorative lights 8. As will be explained in greater detail below, a user can operate the device by pressing the actuating button 2, and speaking into the microphone 3. The present disclosure is not limited to one button 2 and microphone 3, but rather can include a plurality of buttons 2 or microphones 3 to enhance the ability of the user to interact with the device. The plurality of decorative lights 8 can communicate to the user, device states such as listening, talking, thinking, sleeping, laughing, onboarding, error, etc. The device states can include any human emotion known to those of skill in the art.

FIGS. 3 and 4 are sectional (cut-away) views of the device revealing its inner components. In particular, the device can include a pushbutton switch 6 in mechanical communication with the actuating button 2. The device can also include a wireless-enabled printed circuit board (PCB) 5 which can be in electrical communication with the pushbutton switch 6. The PCB 5 can include a microprocessor or similar means to known to those of skill in the art for performing the functions of the device as described in the present disclosure. The device can also include a power supply 7 for powering the PCB 5 and electrical components located on the PCB 5 and within the device. The PCB 5 can also be in electrical communication with the microphone 3. The device can include an audio speaker 4 which can also be connected to the PCB and which provides audio signals to the user through the microphone 3.

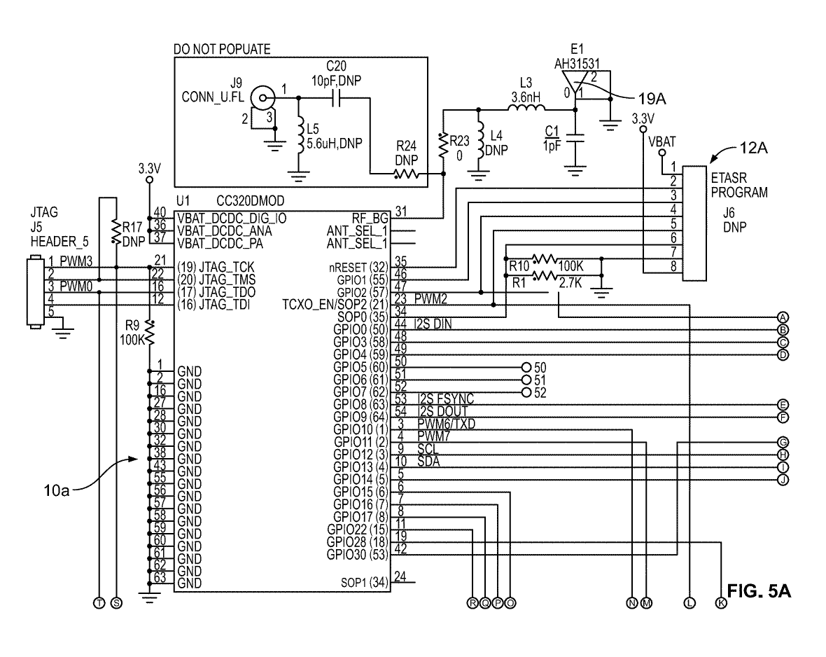

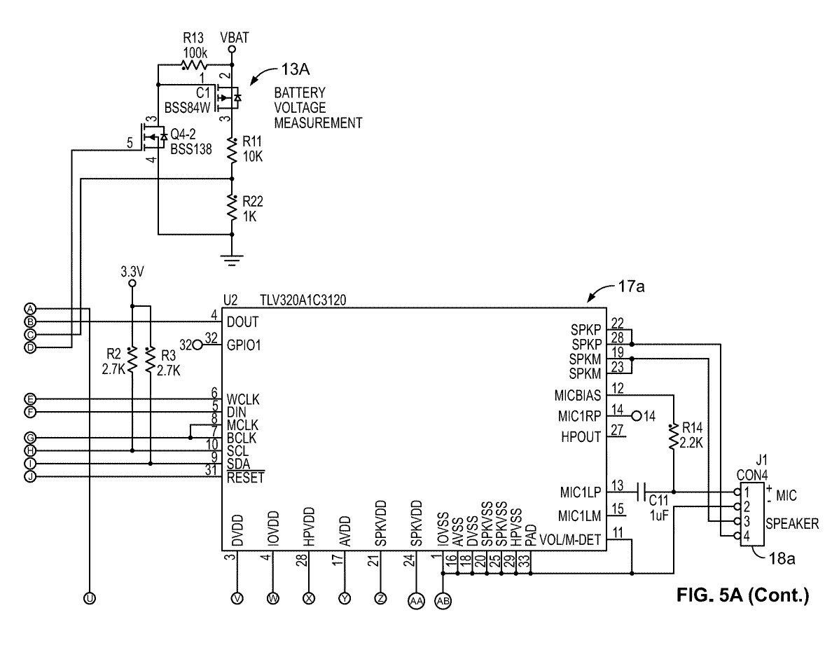

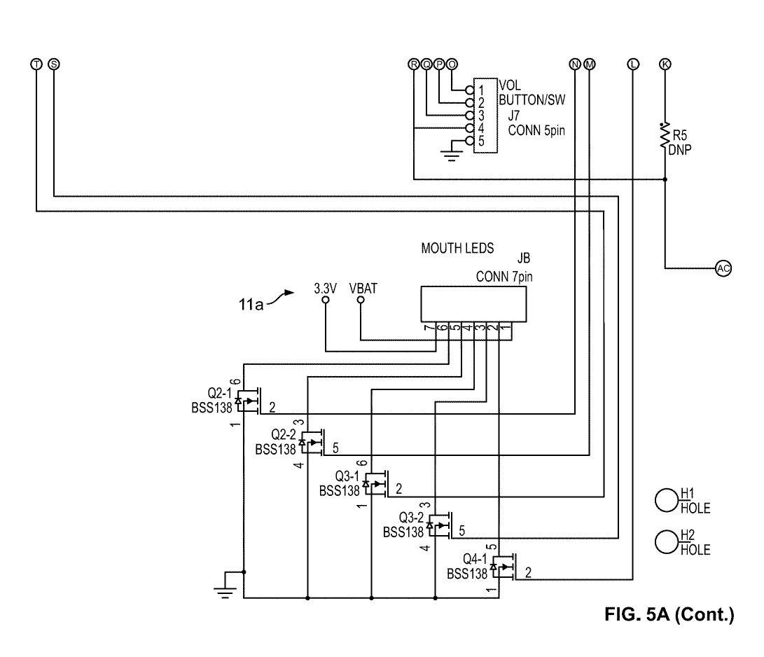

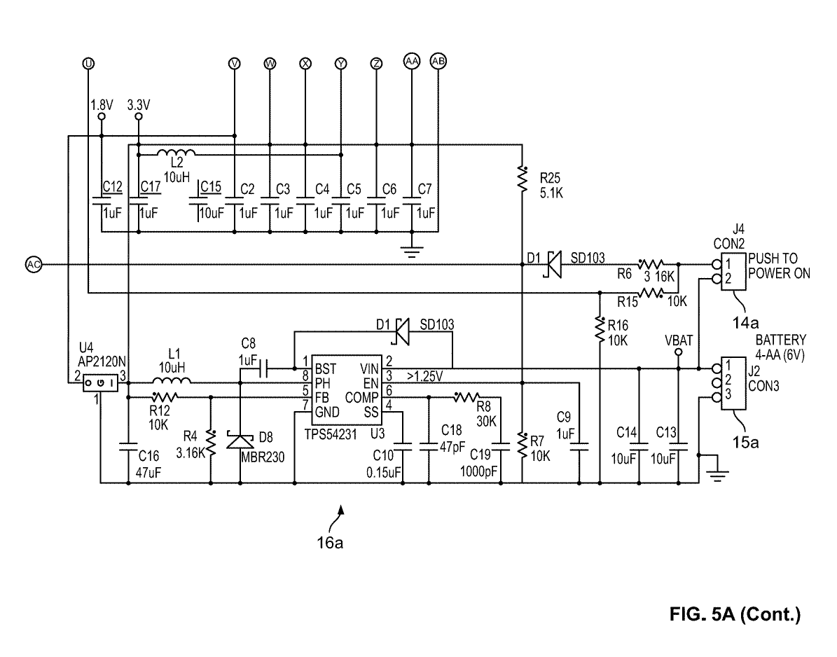

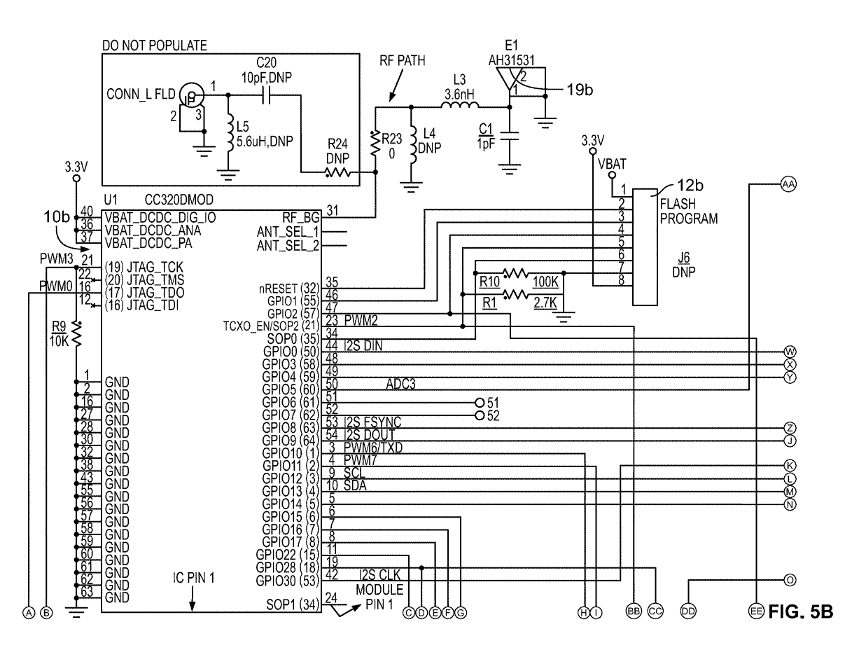

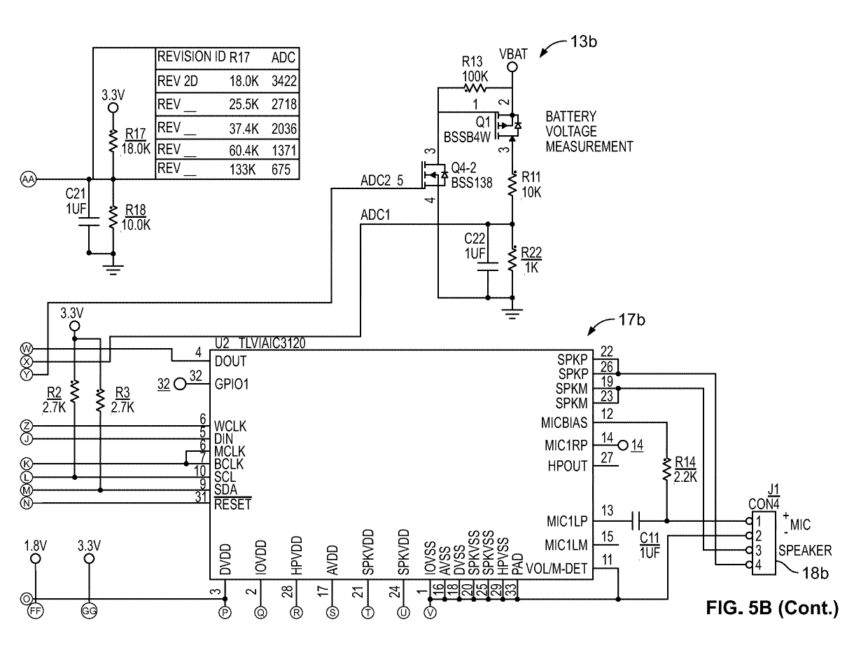

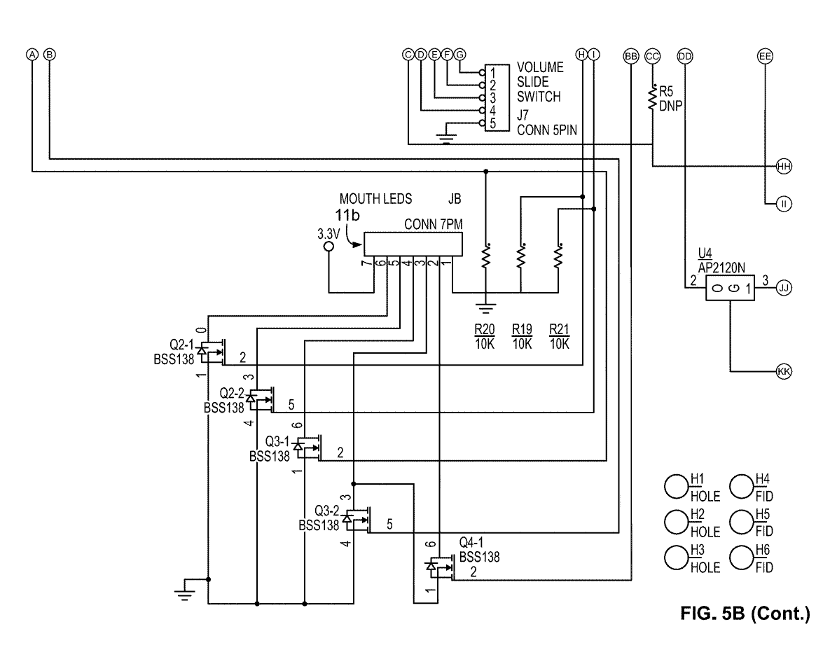

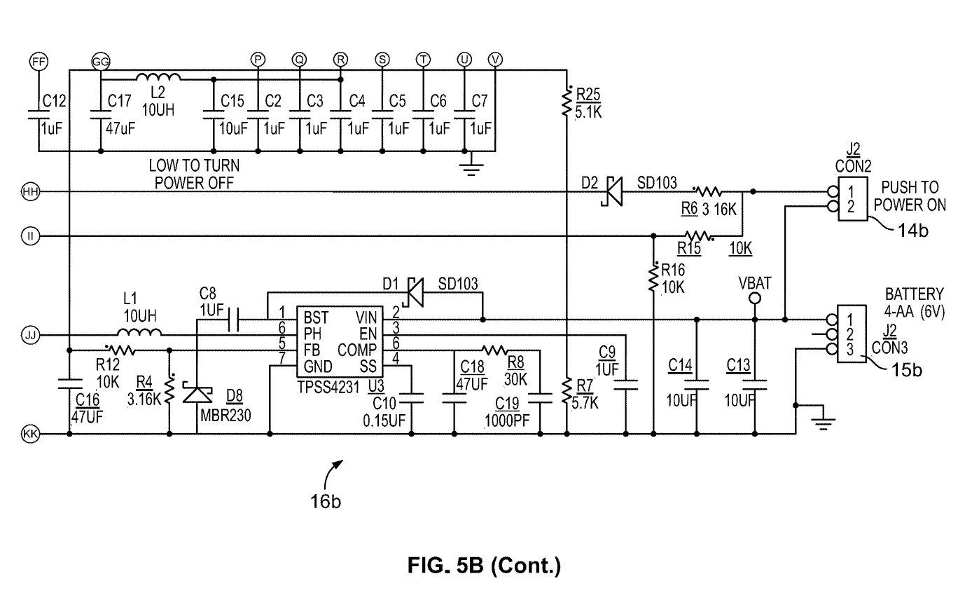

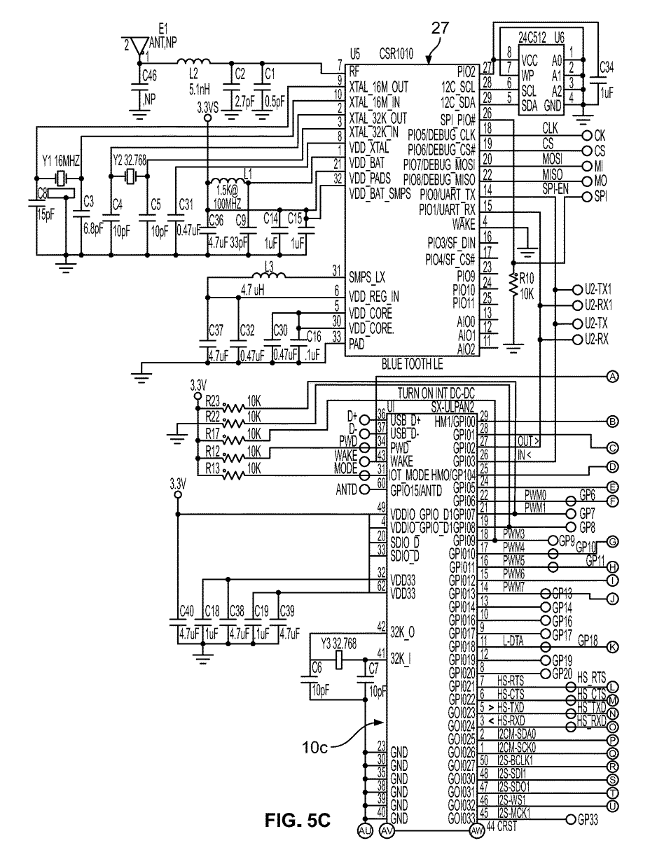

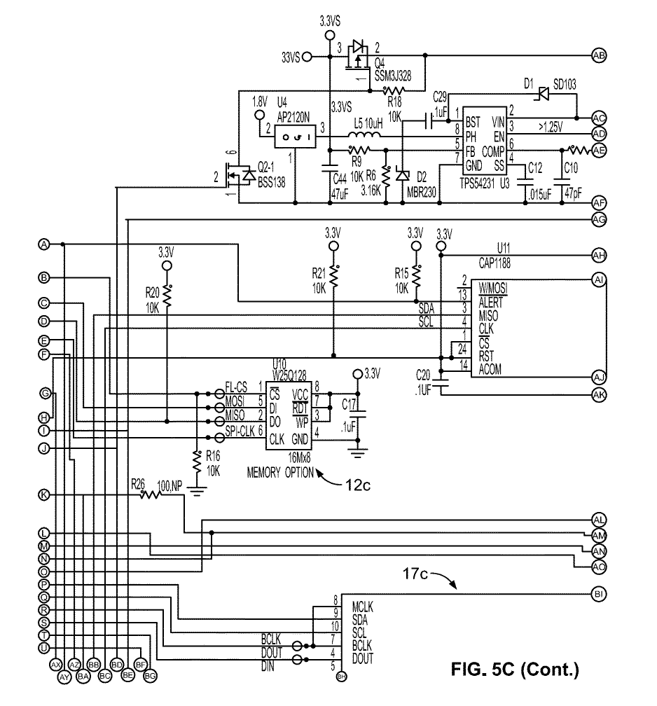

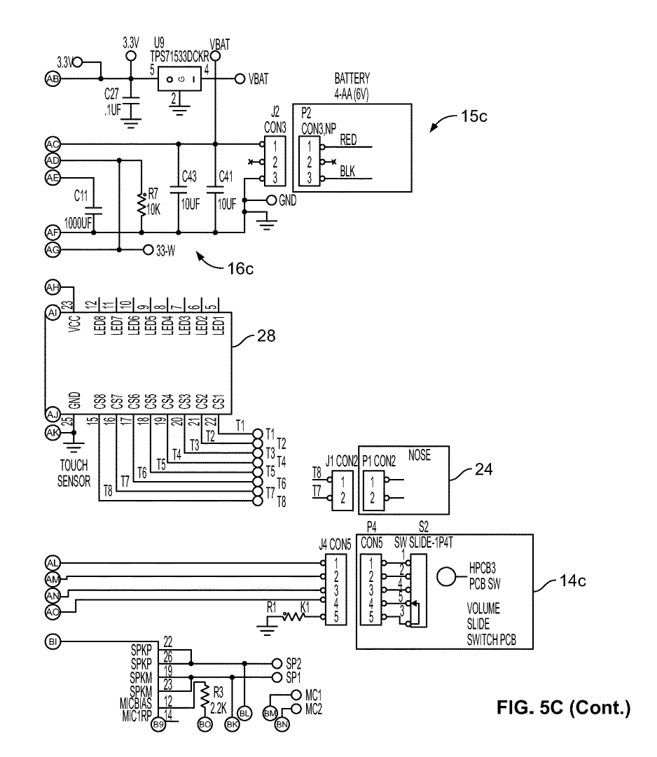

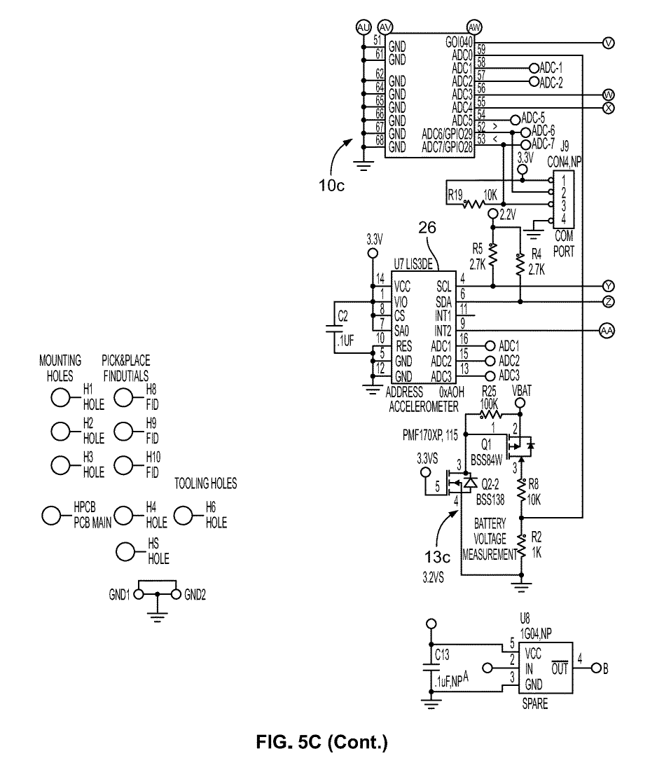

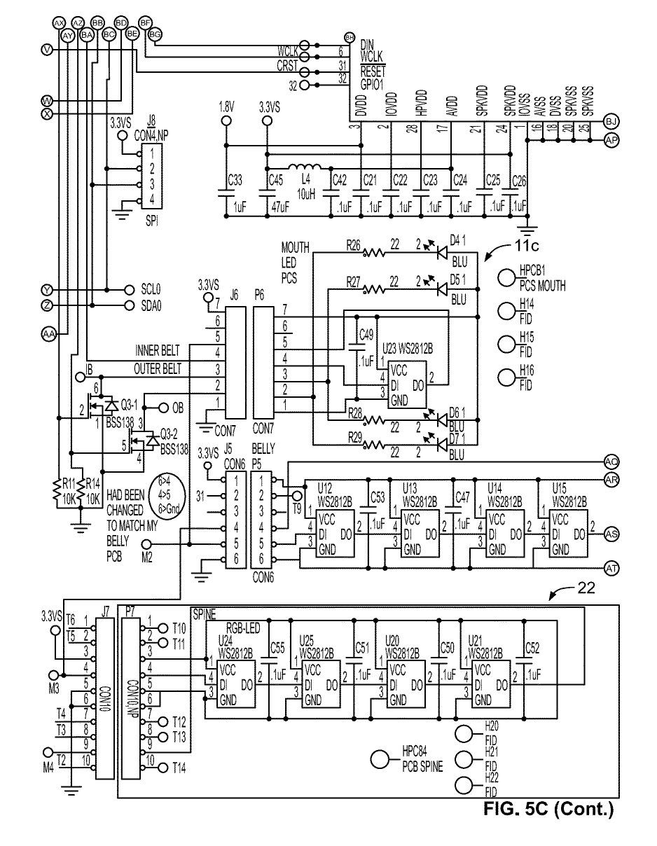

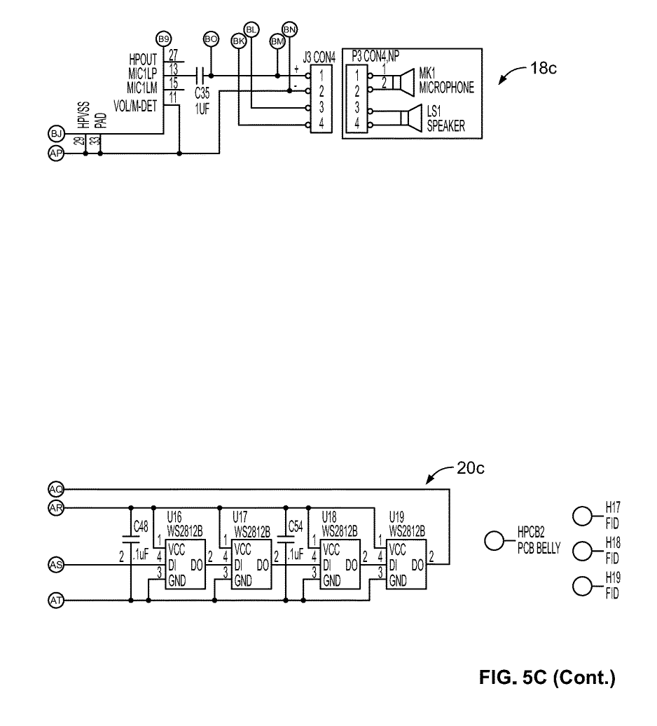

FIG. 5A is an electrical schematic illustrating one embodiment of circuitry of the printed circuit board 5 of the present disclosure. As can be seen, the printed circuit board 5 include a microprocessor 10a for providing the necessary logic to the device for performing the functions of the present disclosure. A person of ordinary skill in the art can appreciate that any microprocessor suitable for receiving, processing, and relaying audio signals can be used. Moreover, the microprocessor can have the necessary electrical components and circuitry to relay signals to a remote server and receive signals from a remote server as will be explained in greater detail below. The hardware can include Wifi and audio capability. The hardware can also connect to global cellular or wireless networks such as LTE, 3G, 4G, etc. The printed circuit board 5 can also include wiring harnesses 11a for connection with a plurality of LEDs (not shown) and the necessary driver circuitry. The LEDs could form the lights 8 of FIG. 1. The plurality of LEDs can be positioned on the mouth of the toy device or on any other portion of the toy. As shown in FIG. 5 each of the LEDs have a corresponding drive transistor and can be in electrical communication with the microprocessor 10a so that the LEDs can be controlled as desired by the system. As noted above, the LEDs can be controlled to convey a system state such as listening, talking, thinking, sleeping, laughing, onboarding, error, etc. The printed circuit board 5 can also include a wiring harness 12a for connection to a device for programming flash memory of the microprocessor 10a. The microprocessor 10a can also have battery voltage measurement circuitry 13a to measure the voltage level of the battery on board the device. The printed circuit board 5 can also include a power switch 14a for allowing a user to turn the device on or off. The printed circuit board 5 can also include a jack 15a for connection with batteries and power supply circuity 16a. Moreover, the printed circuit board 5 can include a codec chip 17a for handling the audio processing as described in detail in the present disclosure. The codec chip 17a is in electrical communication with a microphone and speaker connection 18a. The printed circuit board 5 can also include an antenna 19a for providing wireless connections for the device.

FIG. 5B is an electrical schematic illustrating one embodiment of circuitry of the printed circuit board 5 of the present disclosure. As can be seen, the printed circuit board 5 include a microprocessor 10b for providing the necessary logic to the device for performing the functions of the present disclosure. A person of ordinary skill in the art can appreciate that any microprocessor suitable for receiving, processing, and relaying audio signals can be used. Moreover, the microprocessor can have the necessary electrical components and circuitry to relay signals to a remote server and receive signals from a remote server as will be explained in greater detail below. The hardware can include Wifi and audio capability. The hardware can also connect to global cellular or wireless networks such as LTE, 3G, 4G, etc. The printed circuit board 5 can also include wiring harnesses 11b for connection with a plurality of LEDs (not shown) and the necessary driver circuitry. The LEDs could form the lights 8 of FIG. 1. The plurality of LEDs can be positioned on the mouth of the toy device or on any other portion of the toy. As shown in FIG. 5 each of the LEDs have a corresponding drive transistor and can be in electrical communication with the microprocessor 10b so that the LEDs can be controlled as desired by the system. As noted above, the LEDs can be controlled to convey a system state such as listening, talking, thinking, sleeping, laughing, onboarding, error, etc. The printed circuit board 5 can also include a wiring harness 12b for connection to a device for programming flash memory of the microprocessor 10b. The microprocessor 10b can also have battery voltage measurement circuitry 13b to measure the voltage level of the battery on board the device. The printed circuit board 5 can also include a power switch 14b for allowing a user to turn the device on or off. The printed circuit board 5 can also include a jack 15b for connection with batteries and power supply circuity 16b. Moreover, the printed circuit board 5 can include a codec chip 17b for handling the audio processing as described in detail in the present disclosure. The codec chip 17b is in electrical communication with a microphone and speaker connection 18b. The printed circuit board 5 can also include an antenna 19b for providing wireless connections for the device.

FIG. 5C is an electrical schematic illustrating one embodiment of circuitry of the printed circuit board 5 of the present disclosure. As can be seen, the printed circuit board 5 include a microprocessor 10c for providing the necessary logic to the device for performing the functions of the present disclosure. A person of ordinary skill in the art can appreciate that any microprocessor suitable for receiving, processing, and relaying audio signals can be used. Moreover, the microprocessor can have the necessary electrical components and circuitry to relay signals to a remote server and receive signals from a remote server as will be explained in greater detail below. The hardware can include Wifi and audio capability. The hardware can also connect to global cellular or wireless networks such as LTE, 3G, 4G, etc. The printed circuit board 5 can also include wiring harnesses 11c for connection with a plurality of LEDs (not shown) and the necessary driver circuitry. The LEDs could form the lights 8 of FIG. 1. The plurality of LEDs can be positioned on the mouth of the toy device or on any other portion of the toy. As shown in FIG. 5 each of the LEDs have a corresponding drive transistor and can be in electrical communication with the microprocessor 10c so that the LEDs can be controlled as desired by the system. As noted above, the LEDs can be controlled to convey a system state such as listening, talking, thinking, sleeping, laughing, onboarding, error, etc. The printed circuit board 5 can also include a wiring harness 12c for connection to a device for programming flash memory of the microprocessor 10c. The microprocessor 10c can also have battery voltage measurement circuitry 13c to measure the voltage level of the battery on board the device. The printed circuit board 5 can also include a power switch 14c for allowing a user to turn the device on or off. The printed circuit board 5 can also include a jack 15c for connection with batteries and power supply circuity 16c. Moreover, the printed circuit board 5 can include a codec chip 17c for handling the audio processing as described in detail in the present disclosure. The codec chip 17c is in electrical communication with a microphone and speaker connection 18c. The printed circuit board 5 can also include an antenna 19c for providing wireless connections for the device. The printed circuit board 5 can also include a plurality of belly LEDs 20 which can be positioned on the belly of the toy. The printed circuit board 5 can also include a plurality of spine LEDs 22 which can be positioned on the spine of the toy (e.g., dinosaur animal shape). The printed circuit board 5 can also include a plurality of nose LEDs 24 which can be positioned on the nose of the toy. The printed circuit board 5 can also include an accelerometer 26 which can be in electrical communication with the microprocessor 10. Based on the movement of the device or toy detected by the accelerometer 26, the toy or device can sense such a movement and provide an audio response to the user or flash the LEDs in a way that is responsive to the detected movement. For example, if a child or user of the toy starts shaking the toy, the accelerometer 26 can detect the shaking, and respond by saying “please stop shaking me” or pulse the LEDs quickly to be responsive to the movement. Moreover, if the accelerometer 26 detects a rocking movement, the toy or device can respond by saying “thank you” or perhaps send a yawning audio signal to a user indicating that the toy wants to sleep. Further, the circuitry can include a Bluetooth chip for providing Bluetooth connectivity of the device with any other mobile or smart device. Moreover the printed circuit board can include a touch sensor 28 which can detect when the user is touching the toy and position in which the toy is being touched. Accordingly, the touch sensor 28 is in electrical communication with the microprocessor 10 so that the microprocessor 10 can response to the touching of the toy with audio or visual pulsing or changing of colors of the LEDs.

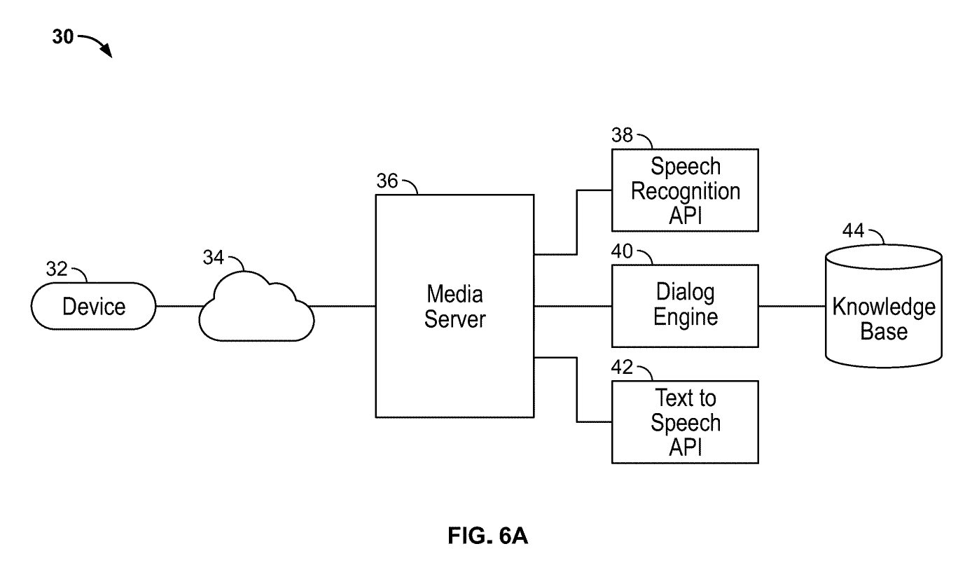

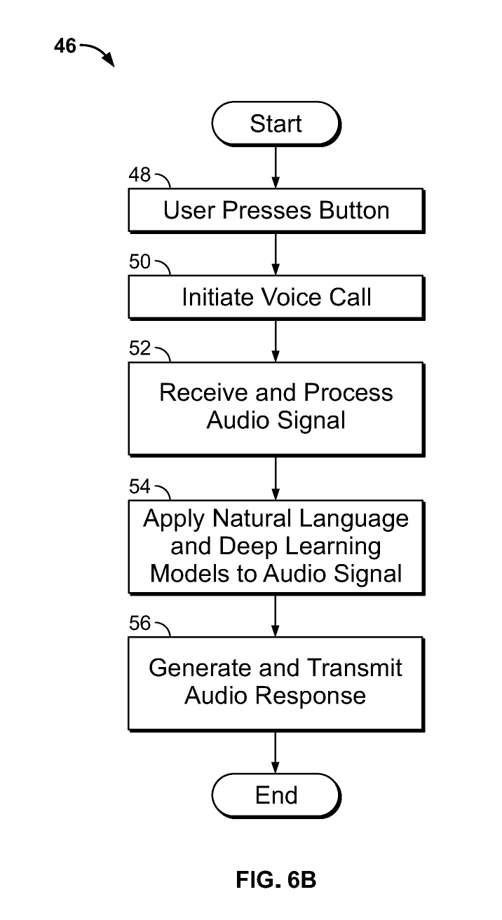

FIG. 6A is a system diagram of a system 30 of the present disclosure. The system 30 can include a device 32, which can be consistent with the device of the present disclosure as explained in greater detail above in connection with FIGS. 1-5C. The user of the device 32 can press the actuating button 2 which can initiate a voice call (Push to Talk). The voice call can be implemented in any way known to those of skill in the art for performing the functions of the present disclosure. In particular, the voice call can be implemented as a transfer protocol such as Store and Forward, or Session Initiation Protocol (SIP), or RFC 4964. Accordingly, the device 32 can function as an embedded SIP client, which collects audio streams and transmits these streams via a voice call or any transfer protocol. Once the user of the device 32 initiates the voice call by pressing the actuating button 2 and speaking into the microphone 3, the device 32 can use the Internet 34 to communicate with a media server 36, which can be remote or local. The voice call and the communication between the device 32 and the media server 36 can allow a user to query a knowledge engine over the cloud using natural speech by speaking into the microphone 3 of the device 32. In particular, the media server 36 can receive an audio signal generated by the user of the device 14 by speaking into the microphone 3. The media server 36 can use a speech recognition API 38 dialog engine 40, a text-to-speech API 42, and a knowledge database 44 in communication with the dialog engine 40. The database 44 can include modules such as speech recognition, syntactic processing, semantic processing, knowledge tracing, and data mining. The media server 36 can all of the aforementioned components to process the audio signal generated by the user of the device 32, and to generate a response to be played to the user of the device 32 via the audio speaker 4. Voice calls can be directed to a purpose-specific SIP network endpoint that runs software such as, but not limited to, FreeSwitch. The device can operate on a wide variety of host networks that can use a variety of NAT or firewall functionality. The device can employ an audio codec for transmitting audio signals.

Encryption of the media and signaling channels can be used in the system of the present disclosure. Audio or voice calls can be half duplex, or can be full duplex if Automatic Echo Cancellation is employed. The device can be capable of sustaining at least one SIP call at any instant in time. The device can be configured to receive SIP calls, but need not do so. The device can be configured to support at least one codec, and can include more. The device can be configured to support at least one media session in any call.

FIG. 6B is a flowchart illustrating processing steps 46 for communication between the device 32 and a user of the device 32. In step 48, a user presses a button to initiate interaction with a toy. In step 50, the device 32 can initiate a voice call (e.g., SIP call) as discussed in detail above. In step 52, the device 32 can receive the audio signal from the user speaking into the microphone of the device 32. The device 32 can process the audio signal in the microprocessor 10 for transmission to the remote server or to another engine within the device 32. In step 54, natural language and deep learning models can be applied to the audio signal to comprehend and understand the real-world situation and provide a meaningful and tailored response to the user. This step will be explained in greater detail below. In step 56, an audio signal can be generated and transmitted to a user through the speaker of the device 32.

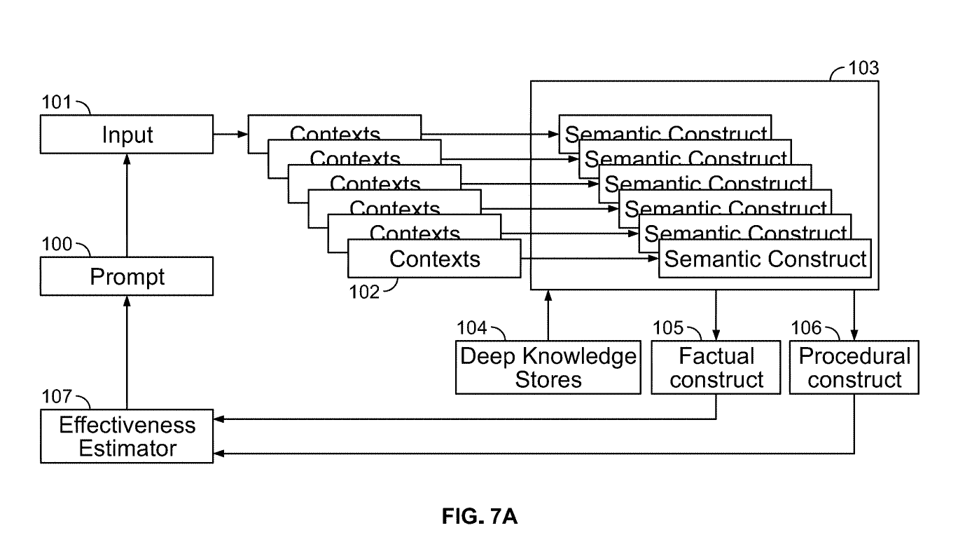

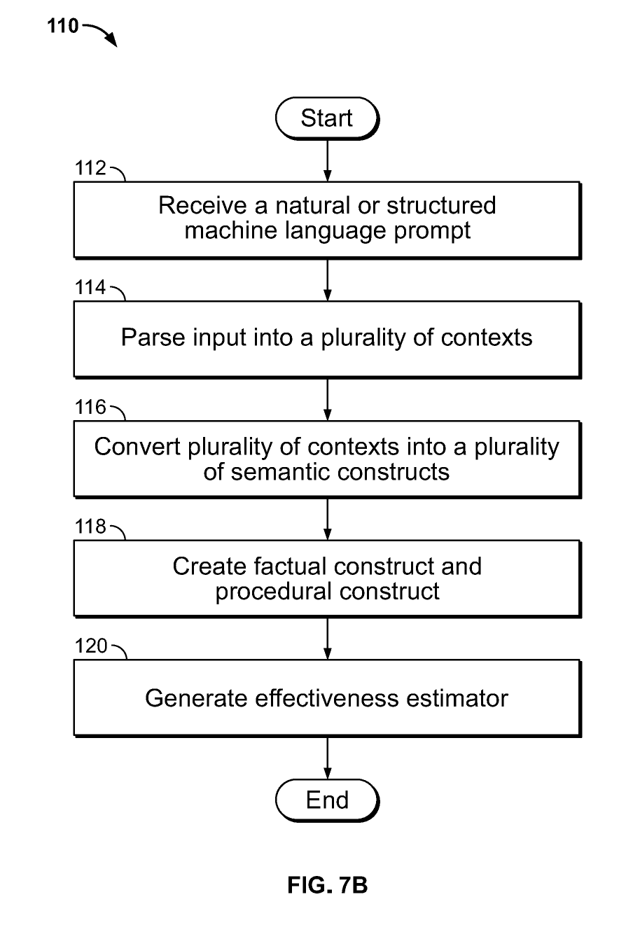

FIG. 7A is a block diagram of the dialog engine 40 (e.g., adaptive learning engine) of FIG. 6A. The dialog engine can be an adaptive language-based learning engine. It can employ a computationally implemented method of creating, maintaining, tracking and augmenting educational context using natural or structured machine language input. The method comprises of a plurality of linguistic-cognitive contexts that encompass deep knowledge of real-world situations, a plurality of factual and procedural construct that amount to completion of learning tasks, and a method for measuring learning effectiveness as a trigger to switching linguistic-cognitive contexts. The block diagram and method can begin with prompt 100 of an input 101 which can be the audio signal received and transmitted by the device 32. Alternatively, the method can solicit an input by providing a natural or structured machine language prompt 100 to the user. Input 101 can be parsed into a plurality of contexts 102, each of which can be converted into a semantic construct 103. Each linguistic-cognitive context 102 can include deep knowledge stores 104 and with the semantic constructs 103, the system and method can comprehend the nature of real-world objects and their connective relations. The plurality of semantic constructs 103 with a deep knowledge store 104 can create factual construct 105 and procedural construct 106. The factual construct 105 and the procedural construct 106 can be used to generate an effectiveness estimator 107. These data points can then be used to generate an audio response to be played to the user of the device 32. Moreover, each factual construct 105 can include a two-way relation between a named entity and an explanatory description of such entity. The relation can be used to evaluate validity of inputs. Each procedural construct 106 can also include a series of demonstrable steps that elicits a plurality of pathways of demonstration. The pathways marked with validity can be used to evaluate validity of inputs. The method can also measure learning effectiveness as a trigger to switching linguistic-cognitive contexts. Furthermore, the system and method can estimate learning effectiveness from validity of inputs, likelihood of false-positives, likelihood of false-negatives, and arduousness of demonstrating effectiveness by construct evaluation.

FIG. 7B is a flowchart illustrating processing steps 110 for semantic reasoning of natural language of the present disclosure. In step 112, a natural language prompt or structured machine language prompt can be received. Alternatively, an audio signal generated by the device 32 can be received. In step 114, the input can be parsed into a plurality of contexts. In step 116, the plurality of contexts can be converted into a plurality of semantic constructs. In step 118, factual constructs and procedural constructs can be created as described in detail above. In step 120, an effectiveness estimator can be generated as discussed in greater detail above.

FIGS. 8-24 show a content management interface for a “Parent Panel,” which allows third parties (such as guardians) to customize, configure, and navigate reports from the platform. FIG. 8 shows a dashboard or home view 200, making a plurality of metrics 202 available, providing guardians an overview of system usage, and provides a drilled down report. Metrics can be displayed on a dashboard that describes a child's interaction with the platform.

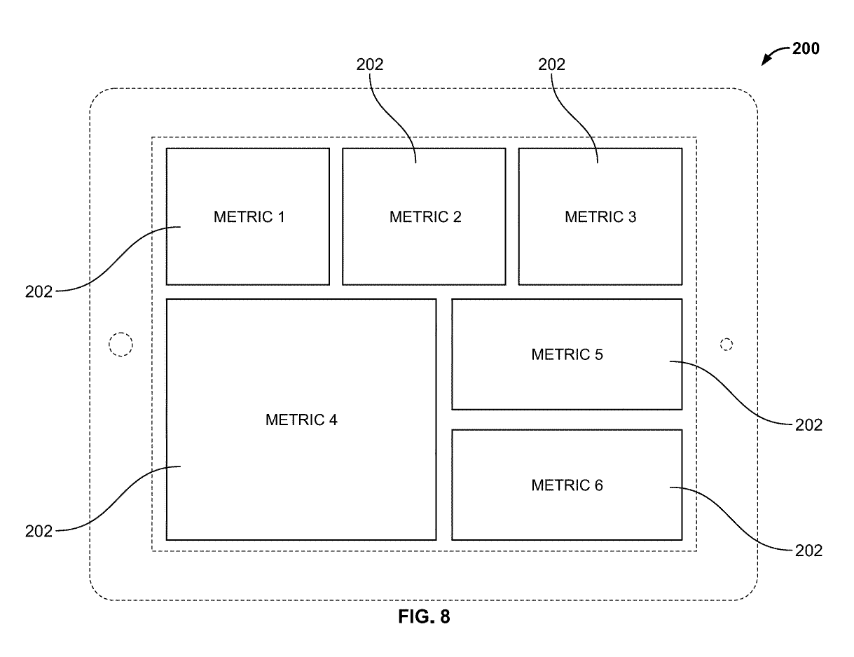

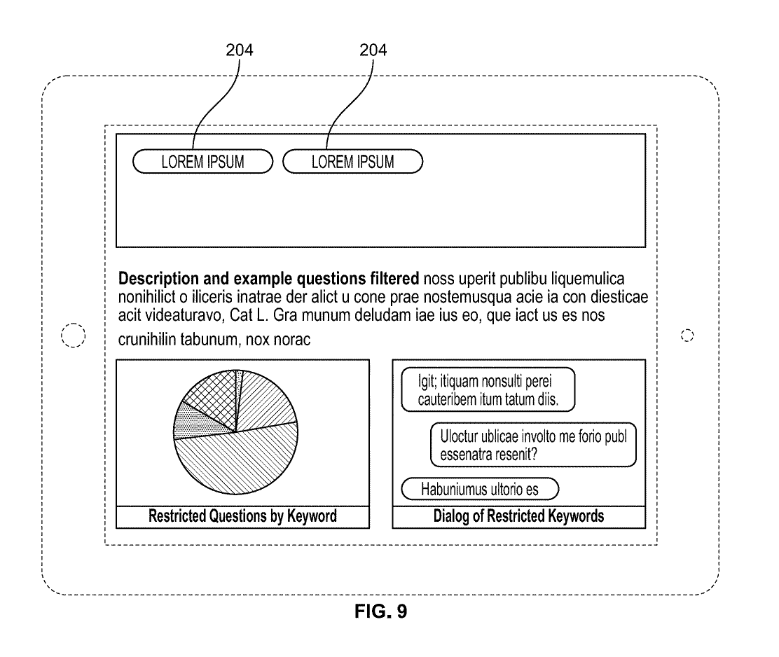

FIG. 9 shows a keyword filtering panel. This panel allows guardians to enter restricted keywords 204. It provides: color coding to indicate if a keyword is blocked or redirected to parent; provides a breakdown of restricted interaction displayed below key entry; a dialog of restricted entry; and restricted questions asked, by keyword.

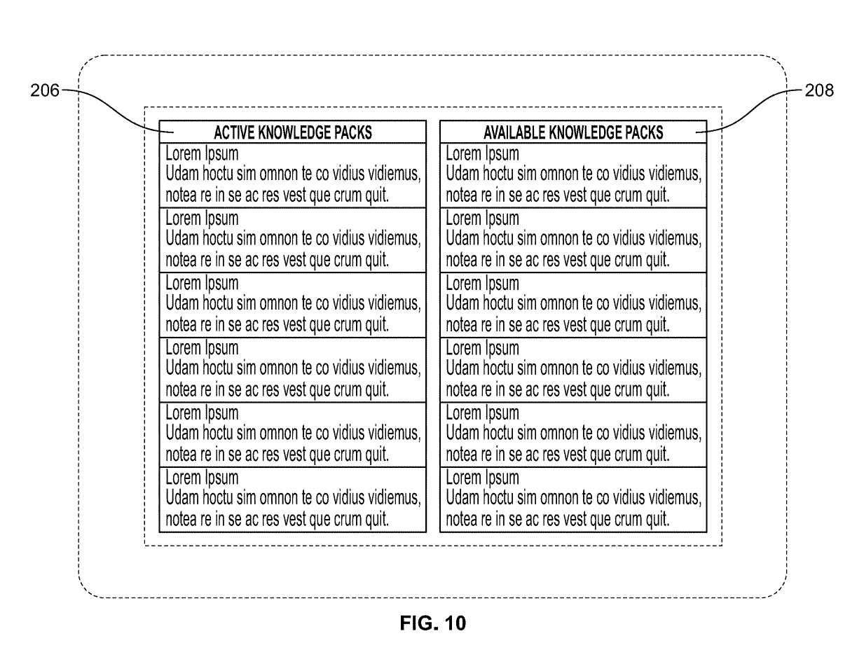

FIG. 10 is a screenshot showing a view providing a parent with a list of active knowledge packs and available knowledge packs. These knowledge packs can be used to educate and interact with the child through the device 34.

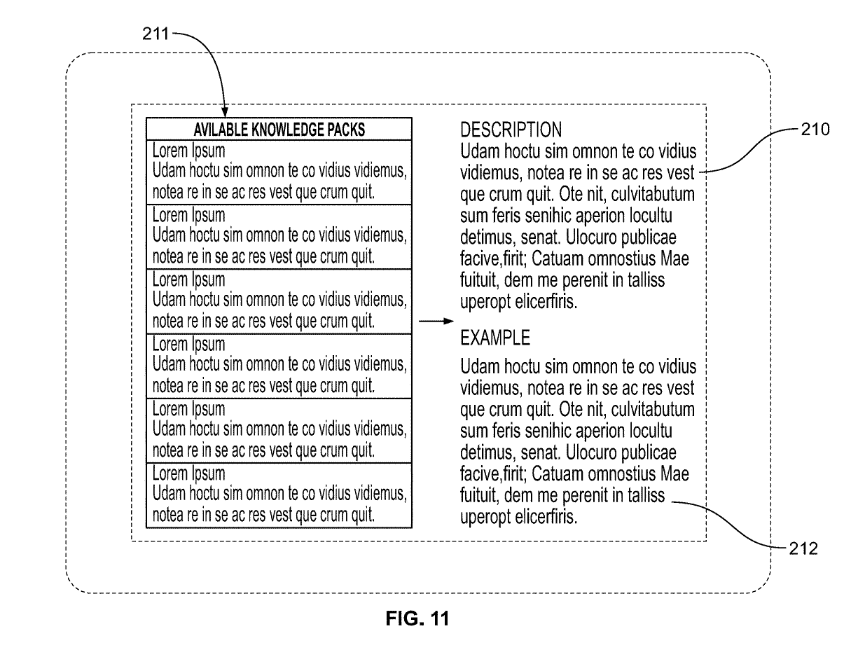

FIG. 11 is a screenshot illustrating a screen where an available knowledge pack 211 is selected. As can be seen, once an available knowledge pack is selected, a description 210 and example 212 of the knowledge pack can be displayed to the parent.

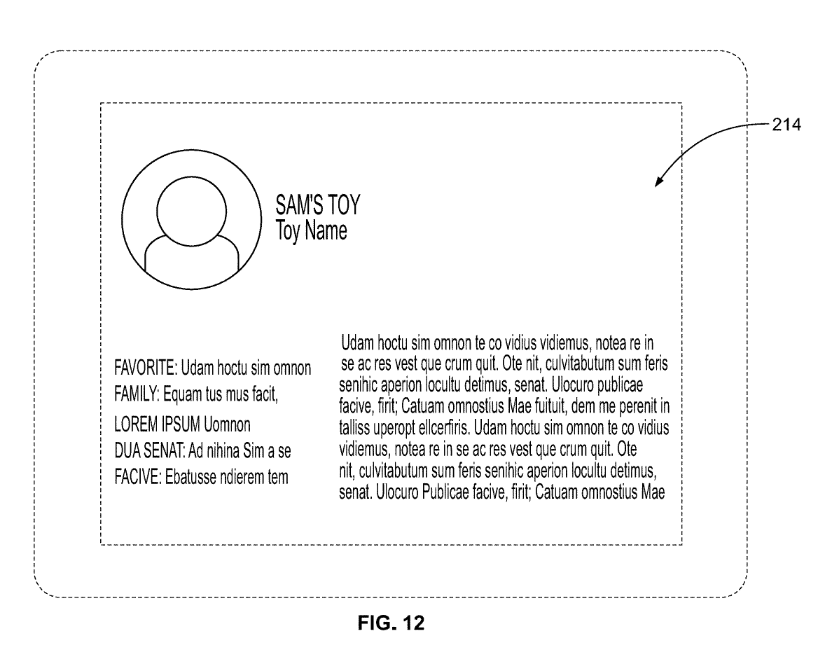

FIG. 12 is a screenshot of child's profile 214. The child profile screen can include the name of the child and the name of the toy. The child profile can also include a favorite thing of the child, the child's family, and other identifying features to allow the toy to better learn and tailor its interaction with the child. This is a panel for direct parental manipulation and setting of dialog variables such as favorite food, color, toy as well as age, name and other personalization information.

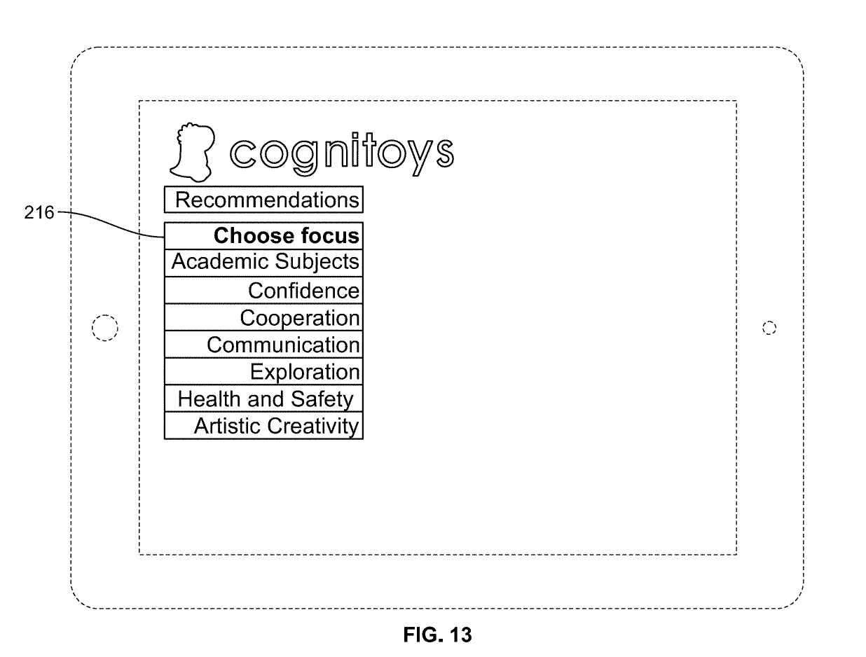

FIG. 13 is another embodiment of the dashboard as described in FIG. 8. A menu 216 allows the guardian to choose the content area or learning topic he or she wishes to browse. Any of the menu or screens as discussed in the present disclosure can be provided in the menu 216.

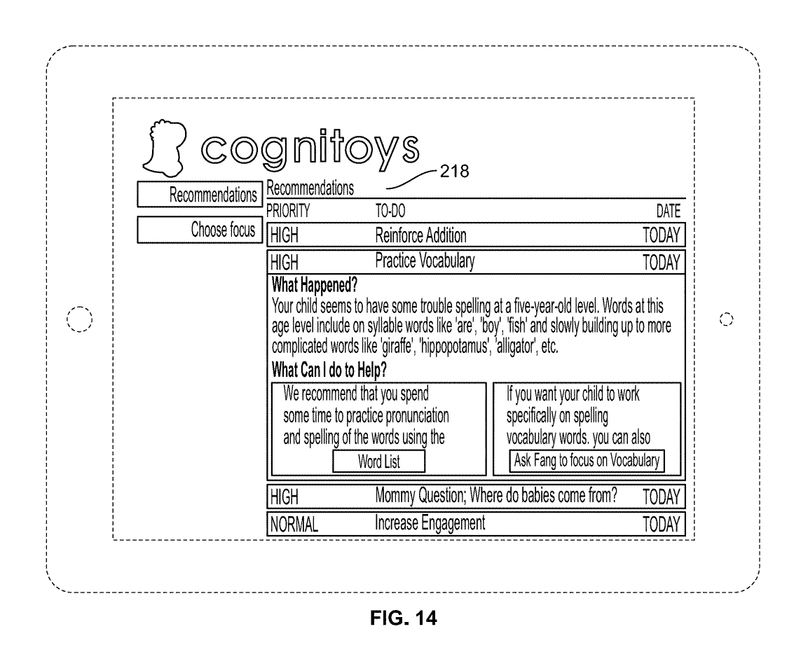

FIG. 14 is a screenshot an embodiment of the content management interface that allows a user or parent to make recommendations 218 for content adjustment. In this view, all items which need attention can be aggregated, including different content areas which can be prioritized and dated. The recommendations of FIG. 14 and the dashboard as discussed above and as will be discussed below can be combined so the first thing the parent sees are the high priority items from the system.

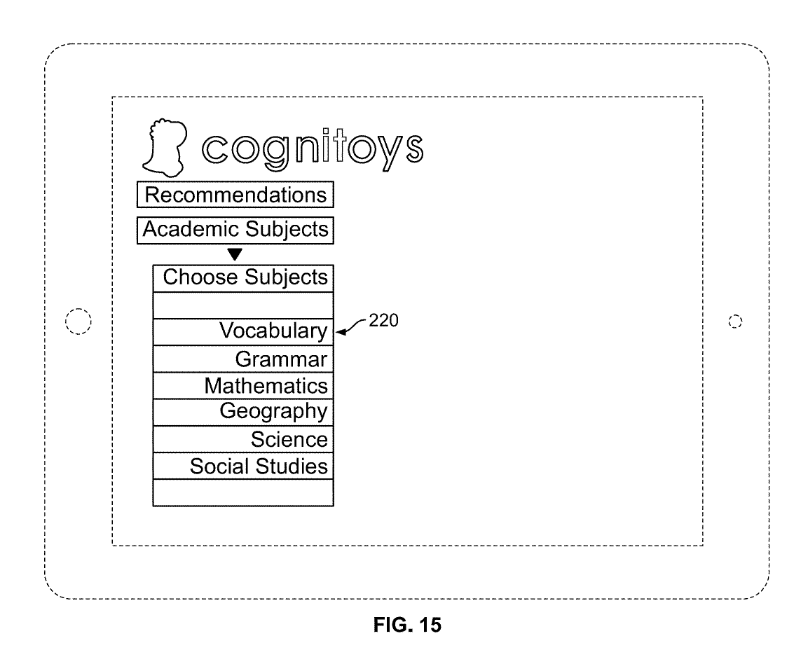

FIG. 15 is a screenshot of an embodiment of the content management interface that allows a guardian or parent to select academic subjects 220, from a tree-structured menu in content organization.

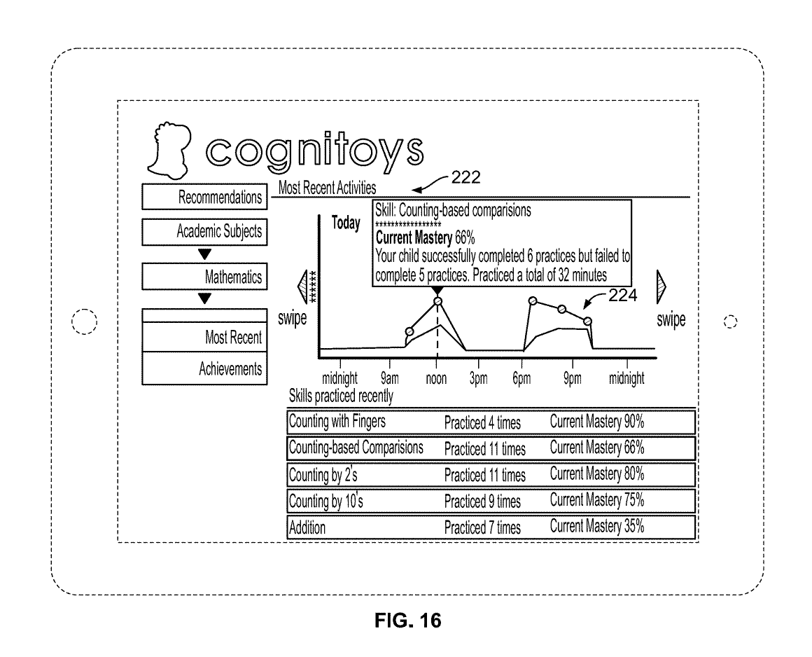

FIG. 16 is a screenshot of an embodiment of the content management interface that shows the device user's (the child's) activity 222, with frames for a particular content area 224 (e.g. Mathematics). Metrics can be displayed in graph form, such as a stacked line graph showing the number of successful trials vs. failed trials at a certain time during the day. A mouse-over tooltip also shows a description of the skill practiced and the child's current mastery of the skill in the form of a percentage.

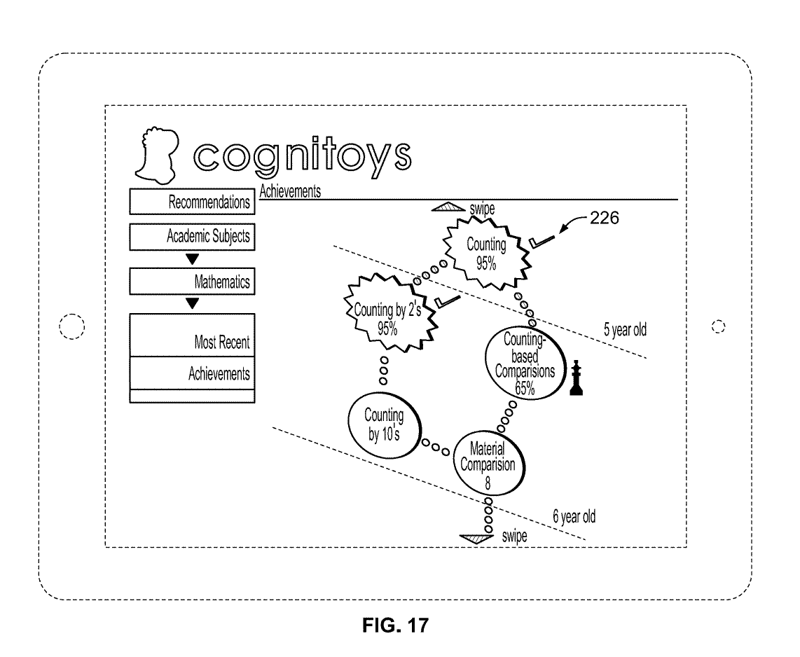

FIG. 17 is a screenshot of a concept for a usage-wide roadmap 226, that shows what the child has learned and where the child should be heading next in the topics. Through conversations, the toy learns the child's basic profile (name, family, likes and dislikes, etc) as well as the child's level of academic competence. Using the learned profile, the device can respond to the child's questions, or to actively ask questions to engage the child in entertainment or educational play.

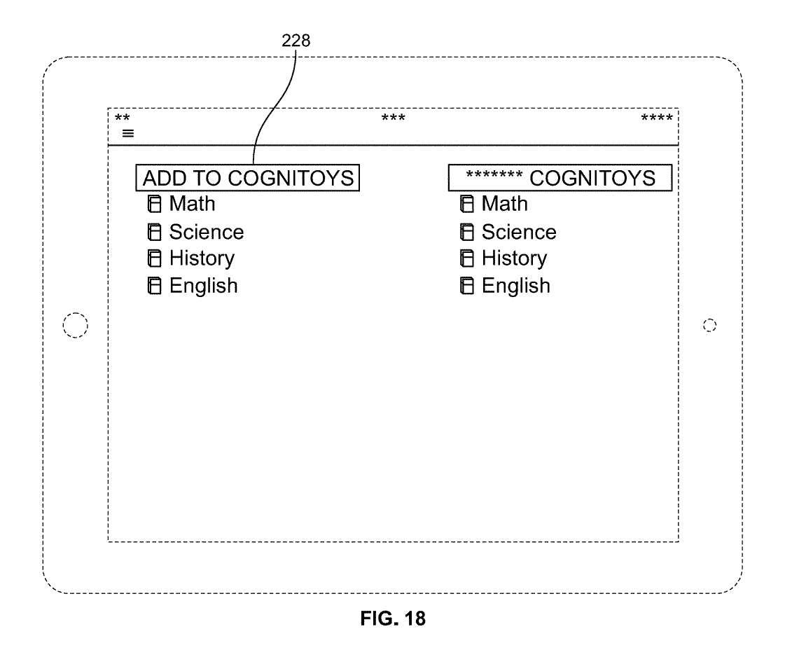

FIG. 18 is a screenshot of a screen for allowing a parent to add educational subjects 228 to the device 34. The subjects can include math, science, history, English or any other subject. The screen can also show a list of subjects already added to the device 34.

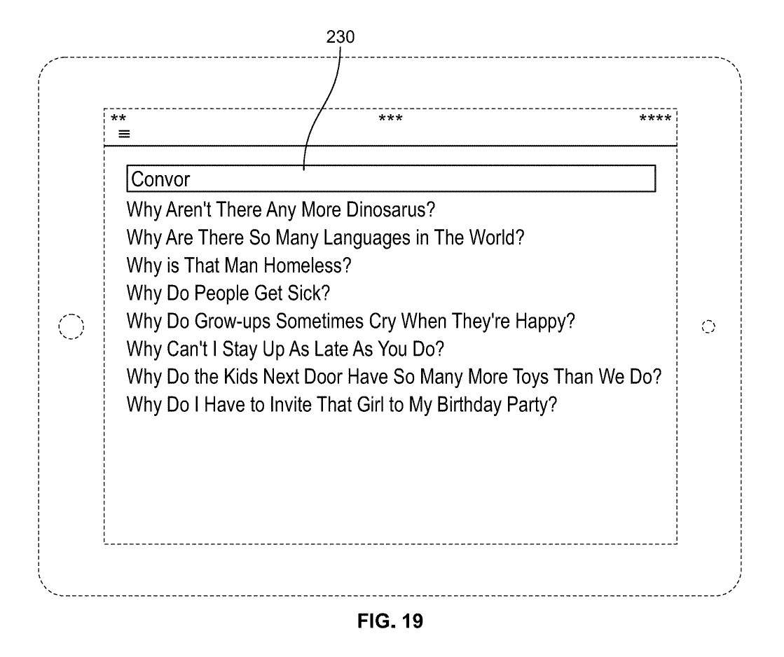

FIG. 19 is a screenshot of a screen showing a list of conversations that are included in the device 34. The parent or guardian can add or remove or modify any of the conversations.

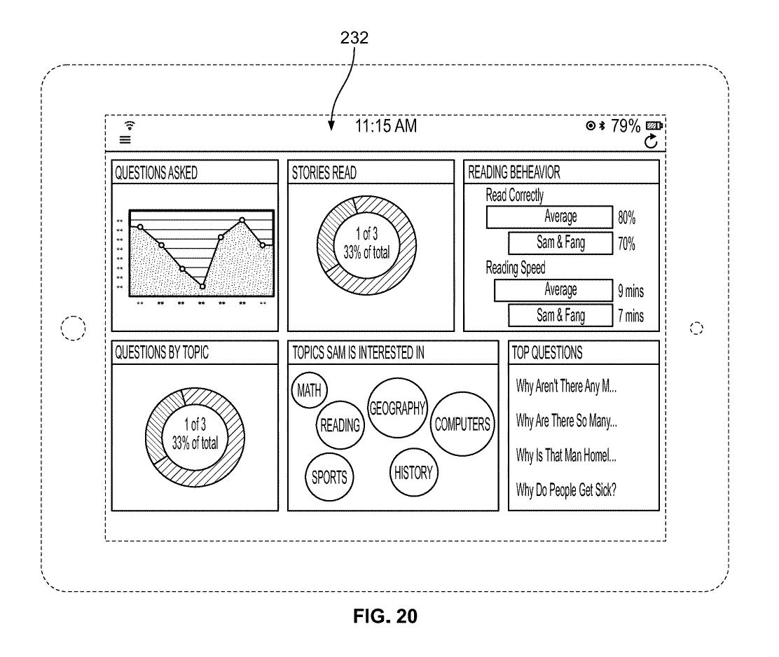

FIG. 20 is a screenshot of embodiment of the Parent Panel interface showing a plurality of metrics 232. The metrics in this panel might include: the number of questions asked by the user per day; the percentage of questions by type (who, when, what, how); the number of words said by the user to date; the number of game triggers per day, such as ‘knock knock jokes’; the closing lines of the dialog.

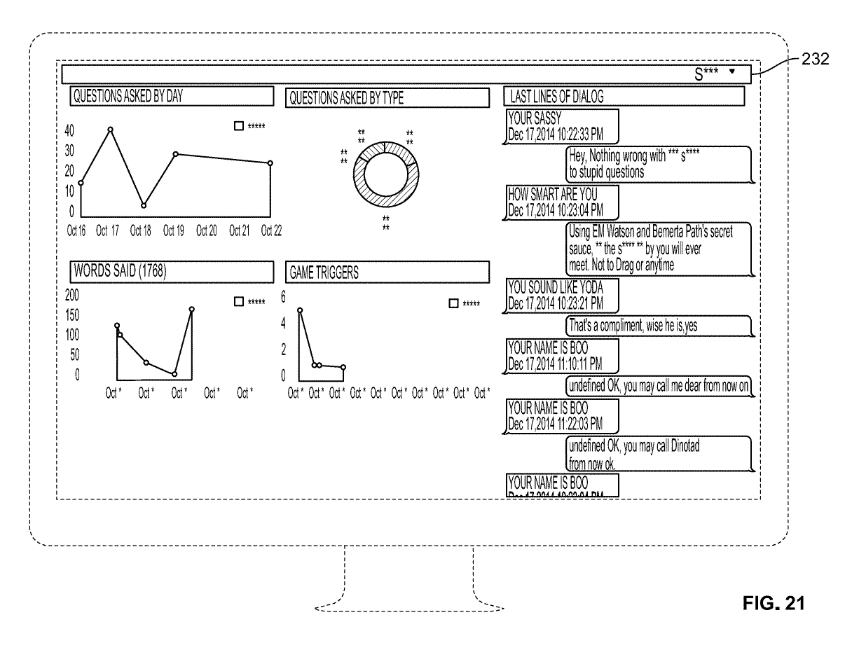

FIG. 21 is a screenshot of the Parent Panel interface as shown on a computer monitor. In particular, FIG. 21 shows the plurality of metrics 232 as shown in FIG. 20 but on a computer monitor. The metrics in this panel might include: the number of questions asked by the user per day; the percentage of questions by type (who, when, what, how); the number of words said by the user to date; the number of game triggers per day, such as ‘knock knock jokes’; the closing lines of the dialog.

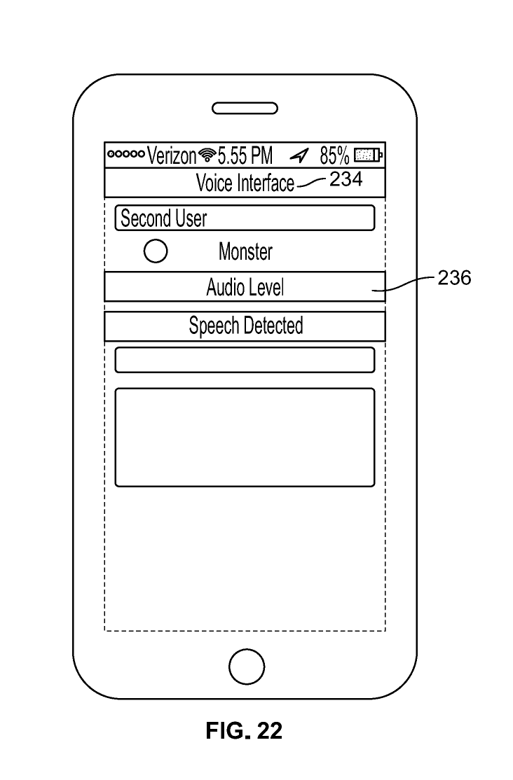

FIG. 22 is a screenshot of the Parent Panel as shown on a smart phone. In particular, the parent can select a voice 234 of the toy such as a monster voice, princess voice etc. The parent can also select and set the audio level 236 of the device 34. Moreover, the parent can view the speech detected by the toy.

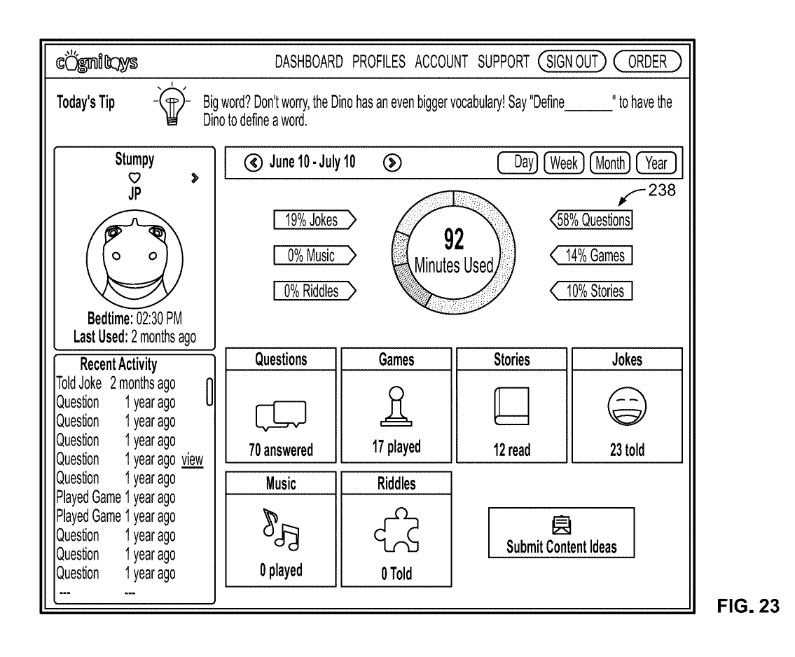

FIG. 23 is a screenshot of a dashboard of the Parent Panel as accessible over the web. As can be seen, a parent can view various metrics 238, such as the amount of time the toy is used and what the toy is being used for. For example, the Parent Panel can show the percentage of time a child uses the toy for jokes, music, riddles, questions, games, and/or stories.

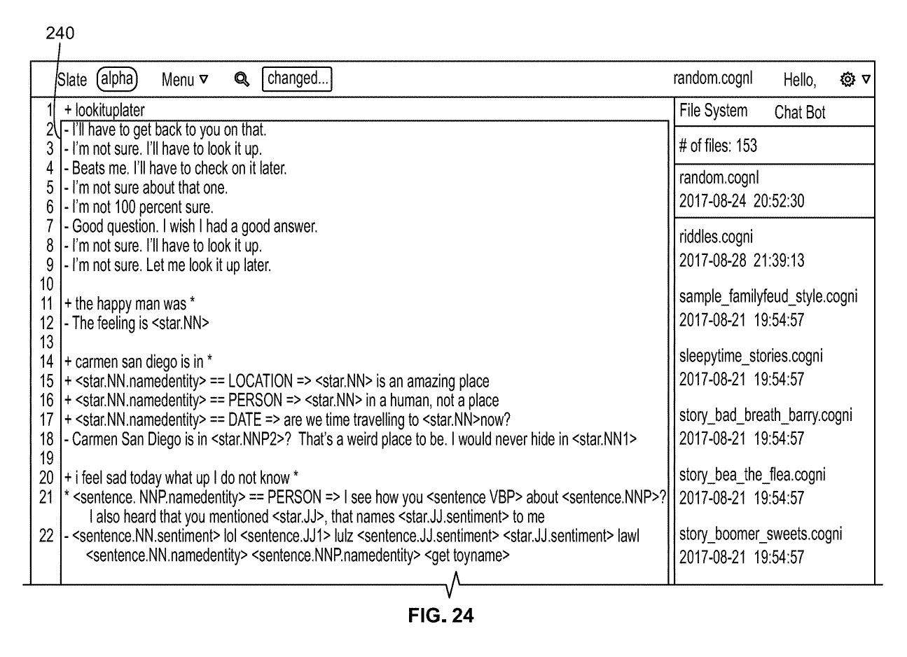

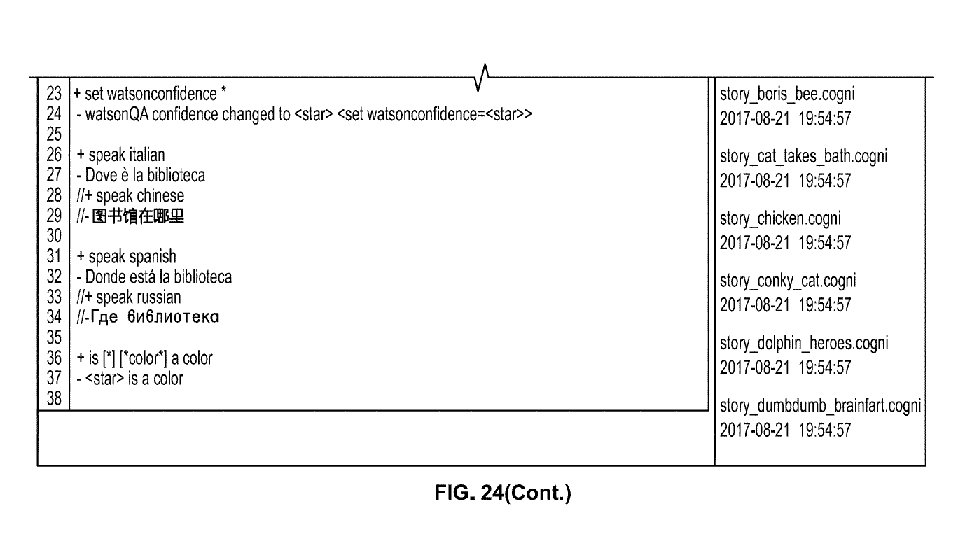

FIG. 24 is a screenshot showing a user interface 240 having software code for responding to a child using the toy. For example, the toy can respond to not knowing an answer and having to look it up later in various different ways so the toy does get boring and repitivie. Also, the toy can be adaptable to many different responses by inserting strings into canned responses. For example, the toy can discuss Carmen San Diego being located anywhere in the world.

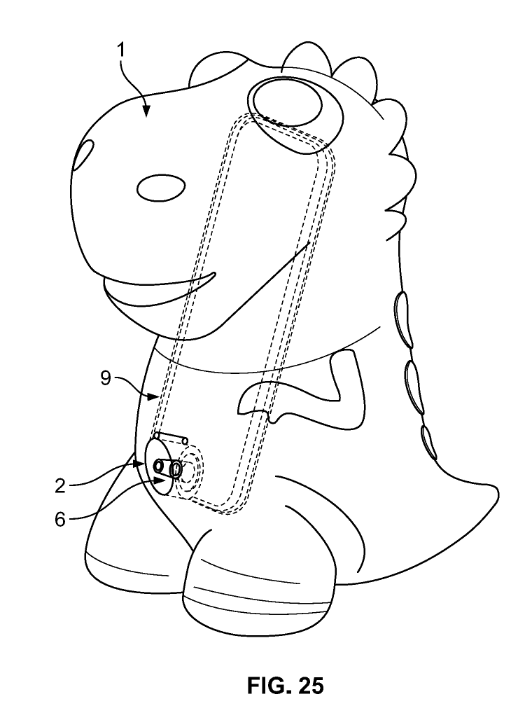

FIG. 25 shows a second embodiment of the device 34. This embodiment is essentially a zoomorphic shell into which a multimedia device can be non-permanently installed. The user operates the device in much the same way as the first embodiment. The user operates the device by pressing on an actuating button 2 which can be coated with a capacitive fabric, which activates a digital button on the multimedia device's 9 digitizer screen, to initiate an interaction with the database. A wifi-enabled multimedia device, or smartphone 9 combines the functions of the microphone 3, speaker 4, PCB 5, and wifi capability.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. A smart toy comprising:
a housing forming a zoomorphic shell for housing internal components;
a microphone for receiving an audio signal from a child;
a speaker for playing a responsive audio signal to the child;
an actuator button;
a microprocessor for establishing a voice call with a remote server when the actuator button is pressed;
wherein the microprocessor processes the audio signal received from the child and sends the audio signal to the remote server;
wherein the remote server processes the audio signal using a dialog engine and a knowledge database to generate the responsive audio signal which is tailored to the child and responsive to the audio signal; and
wherein the remote server sends the responsive audio signal to the microprocessor to be played to the child.

2. The smart toy of claim 1, wherein the voice call is a Session Initiation Protocol.

3. The smart toy of claim 1, further comprising a plurality of LEDs mounted on the zoomorphic shell to convey a system state of the smart toy.

4. The smart toy of claim 3, wherein the plurality of LEDs are located on the mouth of the zoomorphic shell.

5. The smart toy of claim 3, wherein the plurality of LEDs are located on the spine of the zoomorphic shell.

6. The smart toy of claim 3, wherein the plurality of LEDs are located on the belly of the zoomorphic shell.

7. The smart toy of claim 3, wherein the plurality of LEDs are located on the nose of the zoomorphic shell.

8. The smart toy of claim 2, wherein the system state includes at least one of the following:
listening, talking, thinking, sleeping, laughing, onboarding, and error.

9. The smart toy of claim 1, further comprising an accelerometer for detecting movement of the smart toy and providing an audio or visual response based on the movement.

10. The smart toy of claim 1, further comprising a touch sensor for detecting whether the smart toy is being touched and providing an audio or visual response based on the detected touch.

11. A method comprising:
detecting whether a child presses a button on a smart toy;
receiving an audio signal spoken by a child using the smart toy;
initiating a voice call between a microprocessor housed in the smart toy and a remote server;
processing the audio signal at the remote server using a dialog engine and a knowledge database to generate a responsive audio signal which is tailored to the child and responsive to the audio signal; and
transmitting the responsive audio signal from the remote server to the microprocessor to be played to the child.

12. The method of claim 11, further comprising the step of initiating a Session Initiation Protocol as the voice call.

13. The method of claim 11, further comprising the step of using speech recognition API to analyze the audio signal.

14. The method of claim 11, further comprising the step of using a dialog engine to and knowledge database to generate the responsive audio signal.

15. The method of claim 11, further comprising the step of parsing the audio signal into a plurality of contexts.

16. The method of claim 11, further comprising the step of creating a plurality of semantic constructs based on the plurality of contexts.

17. The method of claim 11, further comprising the step of creating a factual construct and procedural construct based on deep knowledge stores and the plurality of semantic contexts.

18. The method of claim 11, further comprising the step of estimating the effectiveness of the responsive audio signal.

19. The method of claim 11, further comprising the step of switching linguistic-cognitive contexts based on a measure of learning effectiveness of the smart toy.

20. A system comprising:
a smart toy having zoomorphic shell and a microprocessor housed within the shell;
a remote server in communication with a knowledge database and having a processor for executing instructions for a dialog engine;
wherein the microprocessor can initiate a voice call between the smart toy and the remote server;
wherein the microprocessor processes an audio signal received from a child using the smart toy and sends the audio signal to the remote server;
wherein the remote server processes the audio signal using the dialog engine and the knowledge database to generate a responsive audio signal which is tailored to the child and responsive to the audio signal; and
wherein the remote server sends the responsive audio signal to the microprocessor to be played to the child.

21. The system of claim 20, wherein the voice call is a Session Initiation Protocol.

22. The system of claim 20, wherein the remote can use a speech recognition API to analyze the audio signal.

23. The system of claim 20, wherein the remote server parses the audio signal into a plurality of contexts.

24. The system of claim 20, wherein the remote server creates a plurality of semantic constructs based on the plurality of contexts.

25. The system of claim 20, wherein the remote server creates a factual construct and procedural construct based on deep knowledge stores and the plurality of semantic contexts.

26. The system of claim 20, wherein the remote server estimates the effectiveness of the responsive audio signal.

27. The system of claim 20, wherein the remote server switches linguistic-cognitive contexts based on a measure of learning effectiveness of the smart toy.
